(19) United States
(12) Patent Application Publication
(10) Pub. No.: US 2008/0288574 A1
(43) Pub. Date: Nov. 20, 2008

(54) Methods and Apparatus for Selectively Transferring Data Objects to a Communication Device

(75) Inventor: Anthony J. Sammarco, Raleigh, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB, Lund (SE)

(21) Appl. No.: 11/969,959

(22) Filed: Jan. 7, 2008

Related U.S. Application Data
(60) Provisional application No. 60/938,108, filed on May 15, 2007.

(51) Int. Cl. G06F 15/16

(52) U.S. Cl. 709/201

(57) ABSTRACT

Disclosed are methods and apparatus for controlling the transfer of data objects to a communication device based on a comparison of one or more attributes of the data object to a delivery profile, which may reflect a device user's preferences. An exemplary method disclosed herein comprises detecting the occurrence of a trigger event related to communication between two devices and identifying a data object in response, based on one or more of a trigger event type, an identifier for the first communication device, and an identifier for the second communication device. The method further comprises comparing at least one content attribute for the data object to a pre-determined delivery profile corresponding to the second communication device and selectively delivering the data object to the second communication device based on the comparison.

### RELATED APPLICATIONS

The present application claims priority under 35 U.S.C. Section 119(e) to provisional application Ser. No. 60/938,108, filed May 15, 2007, the contents of which are incorporated by reference herein.

### BACKGROUND

The present invention relates generally to communication systems. More specifically, the invention relates to the transfer of data objects between communication devices in a communication system.

With the convergence of voice and data communication networks, portable communication devices are increasingly likely to support several communication modes, as well as a number of communication-related applications. Single-purpose cellular phones and alphanumeric pagers have given way to complex mobile devices supporting voice communications, e-mail, and instant messaging. A typical device often includes a camera, a music player, and sound recorder, and may include a global positioning system (GPS) receiver. Many of these devices and their supporting wireless networks now enable simultaneous use of multiple communication modes. Thus, a device user today might engage in a voice call and simultaneously send or receive text messages, digital images, video clips, or the like.

A few applications have been developed to take advantage of this simultaneous availability of multiple communications modes. In particular, several patents and patent application publications describe a so-called Phone Pages system, in which the generation and transfer of multimedia data objects is triggered by various communication-related events. These data objects, or Phone Pages, thus supplement a primary communication session, such as a voice call, an e-mail exchange, or an instant message conversation. The Phone Pages concept is described in the following patents and patent application publications, the contents of which are each incorporated by reference herein: U.S. Pat. No. 6,922,721, titled “Exchange of Information in a Communication System” and issued on Jul. 26, 2005 to Minborg et al.; U.S. Patent Application Publication 2005/0271041 A1, titled “Exchange of Information in a Communication System” and filed on Jun. 1, 2005 by Minborg et al.; U.S. Pat. No. 6,996,072, titled “Method and Apparatus for Exchange of Information in a Communication Network” and issued on Feb. 7, 2006 to Minborg; U.S. Pat. No. 6,977,909, titled “System and Method for Exchange of Information in a Communication Network” and issued on Dec. 20, 2005 to Minborg; and U.S. Patent Application Publication 2006/0114845, also titled “System and Method for Exchange of Information in a Communication network” and filed on Nov. 14, 2005 by Minborg.

The communication techniques and systems described in the preceding references provide a variety of enhancements to conventional modes of communication, facilitating the convenient exchange of various data objects between users of communications devices. These enhancements may be quite valuable both for promoting personal relationships and for supporting business and enterprise communications. However, if unrestrained, the increased flow of data objects may be overwhelming, both for system users and for the system itself.

### SUMMARY

The present invention provides methods and apparatus for controlling the transfer of data objects to a user's communication device by comparing one or more attributes of the data object to a delivery profile. The delivery profile may be uniquely associated with a communication device so that it reflects the device user's preferences and/or the characteristics of the device. In some embodiments, the delivery profile is used solely to determine whether to deliver a particular data object to the communication device, while in others the delivery profile may be used to determine whether to seek consent from a user of the communication device before transferring the data object.

An exemplary method disclosed herein comprises detecting the occurrence of a trigger event related to communication between a first communication device and a second communication device and identifying a data object in response to the detection of the trigger event, based on one or more of a trigger event type, an identifier for the first communication device, and an identifier for the second communication device. The method further comprises comparing at least one content attribute for the data object to a pre-determined delivery profile corresponding to the second communication device and selectively delivering the data object to the second communication device based on the comparison.

In some embodiments, such as those implemented at a data object server, detecting the occurrence of the trigger event may comprise receiving a data object request from the first or second communication device. The data object request may comprise one or more of a parameter indicating the type of trigger event, an identifier for the first communication device, and an identifier for the second communication device for use in retrieving the data object from a database. In other embodiments, such as those implemented at one of the communication devices, the data object may be retrieved from local storage, in response to a detected trigger event, or the data object may be requested from a data object server.

Embodiments of a communication device configured to selectively deliver a data object to another communication device are also disclosed, as are embodiments of a data object server in accordance with several aspects of the invention. Of course, those skilled in the art will appreciate that the present invention is not limited to the above contexts or examples, and will recognize additional features and advantages upon reading the following detailed description and upon viewing the accompanying drawings.

### BRIEF DESCRIPTION OF THE DRAWINGS

FIG. 1 illustrates a communication system according to one or more embodiments of the present invention.

FIG. 2 is a logic flow diagram according to one or more embodiments of the present invention.

FIG. 3 is another logic flow diagram illustrating one or more embodiments of the invention.

FIG. 4 is a block diagram illustrating an exemplary communication device.

FIG. 5 is a block diagram illustrating an exemplary data object server.

### DETAILED DESCRIPTION

The present invention is described below in reference to a wireless telecommunications system providing voice and data services to a mobile device. Various systems providing voice and data services have been deployed, such as GSM networks (providing circuit-switched communications) and GPRS (providing packet-switched communications); still others are currently under development. These systems may employ any or several of a number of wireless access technologies, such as Time Division Multiple Access (TDMA), Code Division Multiple Access (CDMA), Frequency Division Multiple Access (FDA), Orthogonal Frequency Division Multiple Access (OFDMA), Time Division Duplex (TDD), and Frequency Division Duplex (FDD). The present invention is not limited to any specific type of wireless communications network or access technology. Indeed, those skilled in the art will appreciate that the network configurations discussed herein are only illustrative. The inventive techniques disclosed herein may be applied to “wired” devices accessing conventional voice or data networks, as well as wireless devices. The invention may be practiced with devices accessing voice and/or data networks via wireless local area networks (WLANs) or via one or more of the emerging wide-area wireless data networks, such as those under development by the 3^{rd}-Generation Partnership Project (3GPP).

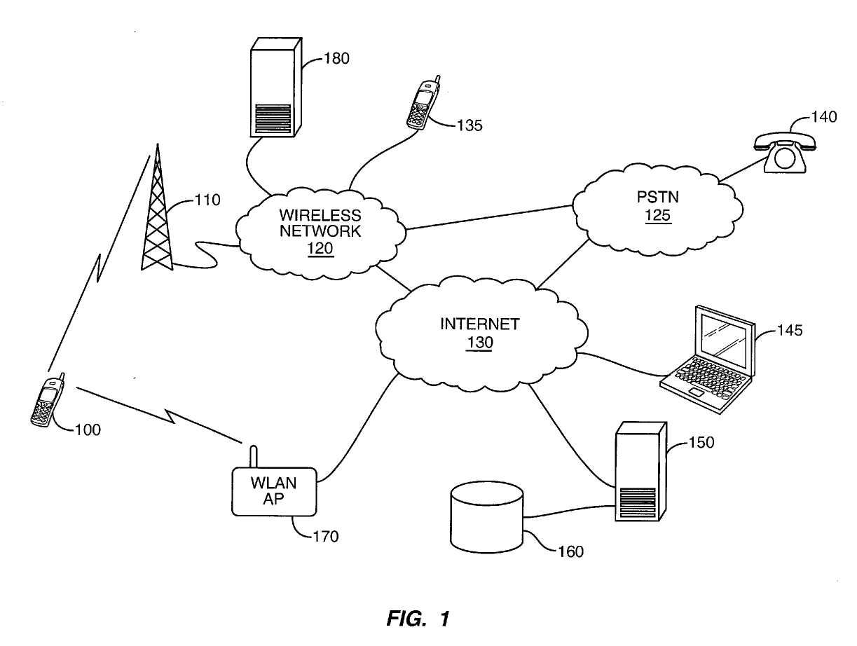

FIG. 1 illustrates an exemplary communications system in which the present invention may be employed. Communications device 100 communicates with other devices through base station 110, which is connected to wireless network 120. Wireless network 120 is in turn connected to the Public Switched Telephone Network (PSTN) 125 and the Internet 130. Wireless device 100 can thus communicate with various other devices, such as wireless device 135, conventional land-line telephone 140, or personal computer 145. In FIG. 1, wireless device 100 also has access to data server 150 via the Internet 130; data server 150 may be configured to provide access through Internet 130 to data or applications stored in storage device 160. Storage device 160 may comprise one or more of a variety of data storage devices, such as disk drives connected to data server 150 or one or more other servers, a Redundant Array of Inexpensive Drives (RAID) system, or the like.

Communications device 100 may be a cordless telephone, cellular telephone, personal digital assistant (PDA), communicator, computer device, or the like, and may be compatible with any of a variety of communications standards, such as the Global System for Mobile Communications (GSM) or one or more of the standards promulgated by 3GPP. Communications device 100 may include a digital camera, for still and video images, as well as a digital sound recorder and digital music player application. Communications device 100 may also support various applications in addition to voice communications, such as e-mail, text messaging, picture messaging, instant messaging, video conferencing, web browsing, and the like.

Communications device 100 also includes a wireless local-area network (WLAN) transceiver configured for communication with WLAN access point 170. WLAN access point 170 is also connected to Internet 130, providing communications device 100 with alternative connectivity to Internet-based resources such as data server 150.

Also connected to wireless network 120 is location server 180. Location server 180 is typically maintained by the operator of wireless network 120, but may be separately administered. The main function of location server 180 is to determine the geographic location of mobile terminals (such as mobile terminal 100) using the wireless network 120. Location information obtained by location server 180 may range from information identifying the cell currently serving mobile terminal 100 to more precise location information obtained using Global Positioning System (GPS) technology.

Other technologies, including triangulation methods exploiting signals transmitted from or received at several base stations, may also be used to obtain location information. Triangulation techniques may include Time Difference of Arrival (TDOA) technology, which utilizes measurements of a mobile's uplink signal at several base stations, or Enhanced-Observed Time Difference (E-OTD) technology, which utilizes measurements taken at the mobile terminal 100 of signals sent from several base stations. GPS-based technologies may include Assisted-GPS, which utilizes information about the current status of the GPS satellites derived independently of the mobile terminal 100 to aid in the determination of the terminal's location.

In some embodiments, the various systems and methods described herein facilitate the selective delivery of data objects to a communication device, such as mobile terminal 125, in communication with another device, such as mobile terminal 100. The data object may be transferred from one device to the other, e.g., from mobile terminal 100 to mobile terminal 125, or from a data object server, such as server 150 or server 180, in response to a request from either of the communication devices.

Typically, the users of the communication devices are engaged in a communication session, which may comprise a voice call (whether circuit-switched or packet-switched), an instant message (IM) session, or any other modes of communication such as those described herein or combinations thereof. In some embodiments, one or both of the communication devices may include a module or application that is able to determine the occurrence of a communications-related trigger event in the communication device and to thereafter transmit and/or receive data, such as data specifically related to the trigger event. The trigger event may comprise, for example, any of the following events or combinations thereof:
the establishment of a session or call between the devices;
the arrival or departure of a device in a multi-party communication session;
activation by the user of one or both of the communication devices (e.g., an explicit request by one user for transfer of a data object to the other);
timer-based periodic or random trigger event in communication device;
crossing a geographic boundary, such as a boundary established by the user of one of the communication devices; or
other events related to the communication, such as those described in U.S. Pat. No. 6,996,072.
   Other trigger events might include, but are not limited to:
An outgoing call is or is about to be initiated.
A called party answers a call.
A called party is busy.
A called party does not answer after a pre-determined time or number of rings.
A called party rejects a call.
A called party is unavailable (e.g., an addressed mobile phone is out of coverage).
An incoming call is imminent or has just started.
A conference call is or is about to be initiated.
A call is disconnected.
A call is conducted (under which several triggering events can be generated).
A party is placed on hold.
The location of a party has changed.
A communication device is switched on or off.
A special-function button is pressed on a communication device.
A button or other user interface device is activated in response to a query.
A voice mail, text message, e-mail, instant message, or the like is received.
A voice mail, text message, e-mail, instant message, or the like is received.
   While many of the preceding trigger events are related to traditional voice communications, those skilled in the art will appreciate that many analogous trigger events will apply to other communication modes, such as instant messaging, e-mail, video conferencing, “chat” sessions, and so on.

In some embodiments, in response to the trigger event, an application in a first device may send—or transmit a request to a data object server for it to send—a data object to a second device, the data object containing data for presentation to the user of second device. In some embodiments, a request to a data object server may include one or more of a parameter indicating the type of trigger, an identifier for the first communication device, and an identifier for the second communication device. One or several of these parameters may be used to retrieve a data object from a database, e.g., one or more of these parameters may be used as an index to a database of data objects.

In embodiments where a data object server is used, the data object server creates or retrieves a data object in response to a data object request, and selectively transfers it to one or both of the communication devices in accordance with the techniques described herein. The data object may comprise data and information related to the trigger event, data or information specifically associated with or stored in one of the communication devices, or any other data or information that may be transmitted via so-called phone pages or data objects.

In some embodiments, before the data object is transmitted to a communication device, or after it is transmitted but before it is presented to the user of the communication device, the user of the target communication device may be queried on whether he wants to receive the transmitted data object. In some embodiments, a decision whether such a query should be presented is based on an evaluation of one or more attributes associated with the content of the data object, such as a content type, title, source, size, or the like. In some embodiments, the query may be sent to the communication device by the data object server before delivering the corresponding data object.

Various methods for presenting the query to the user are possible. For example, a communication device may present a message to a graphical user interface (GUI), the message informing the user of the device that a data object or phone page has been received and is ready for display or presentation. The user may then respond as desired, using conventional user interface devices and techniques. In some embodiments, a user may be queried by voice prompt, or an audio indication may be injected into a voice or audio stream.

In some embodiments, acceptance or rejection of a data object may occur automatically based on a user's predetermined preferences or selections. In some of these embodiments, this rejection may occur before delivery is attempted, based on a delivery profile corresponding to the target communication device. In some cases, this delivery profile may be unique to the target communication device, and may contain user selections or preferences regarding the types of data or information that may be delivered to the device and/or the types of data or information that may not be delivered to the device. In some embodiments, the delivery profile may specify when consent from a user of the device should be solicited before the data object is delivered. The delivery profile may specify various attributes for data objects, for use in such decisions, including the following non-limiting examples:
one or more types of data object (e.g., emergency, data, audio, information, advertisement, music, video, image);
the content of the data object, which may be identified by title, metadata, or the like;
the subject, category, location, time domain, source, author, or other particulars of the data object;
the file type, file size, or the like;
the address/calling party number, or other identifier for the entity, individual, or device that sent or requested the data object; and
the identity of the user sending the data object.

A delivery profile may specify delivery criteria based on one or several content attributes. For example, the delivery profile may specify that a particular user (associated with a particularly device) only wants traffic updates if a location attribute for the user matches a particular city and/or for particular times. In another example, a delivery profile may specify that a user will only accept movie listings on Friday and Saturday after 6:00. Or, a delivery profile may specify that a music file, or a file exceeding 50 kBytes, should only be delivered after seeking consent from the user of the target device.

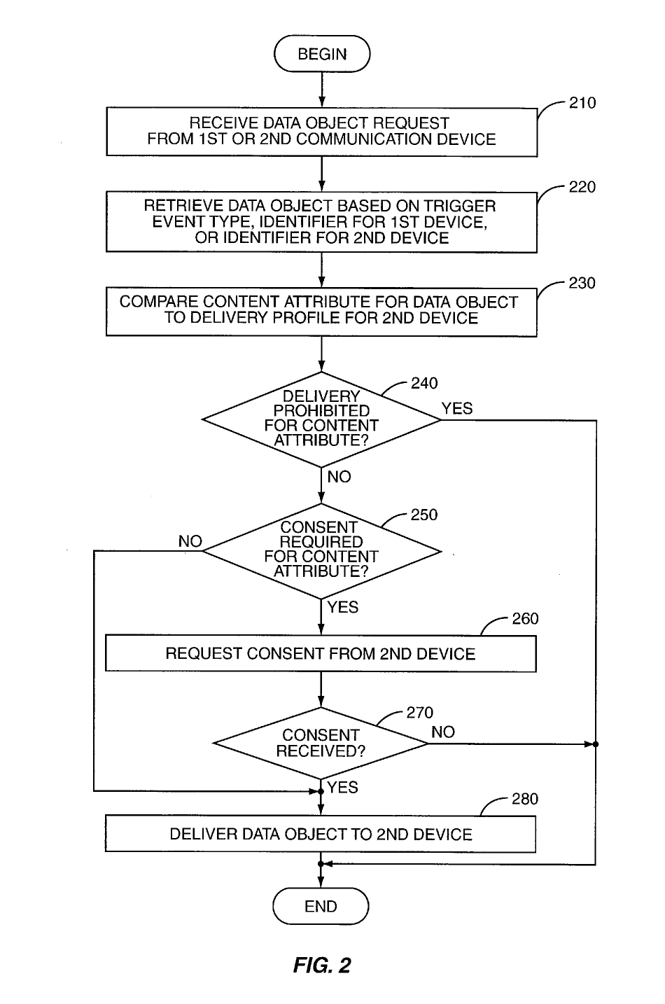

FIG. 2 illustrates one embodiment of a method for selectively delivering a data object, such as might be performed at server 150 or server 180 of FIG. 1. The following description explains the method illustrated in FIG. 2 in the context of implementation at data object server 150, with respect to communication devices 100 and 125. Those skilled in the art will appreciate that other implementations and/or network configurations are possible.

At block 210, data object server 1 50 receives a data object request from one of two or more communication devices engaged in a communication session. Typically, the data object request is triggered by a communications-related event at the requesting device. Thus, by receiving the data object request, the data object server 150 detects, albeit indirectly, the trigger event. The data object request may include, in various embodiments, a parameter identifying the trigger event type, an identifier for the requesting device, e.g. mobile terminal 100, and/or an identifier for a second device in communication with the requesting device.

At block 220, the data object server 150 retrieves a data object. In the pictured embodiment, the data object is retrieved using one or more of the trigger event type and device identifiers for the communication devices. As mentioned above, one or more of these may be included in the data object request itself, but in some embodiments this information might be derived from other signals or messages. In any event, one or more of these parameters may be used to index a database of data objects. For instance, a collection of data objects may be stored at database 160 and indexed by trigger type and/or device identifier. In these embodiments, data object server 150 may simply retrieve the appropriate data object using an indexing parameter. In other embodiments, data object server 150 may assemble a data object, perhaps using a pre-determined data object template and one or more parameters included in or associated with the data object request.

At block 230, one or more content attributes for the data object are compared to a pre-determined delivery profile for the target communication device, here the second mobile terminal 125. In various embodiments, the pre-determined delivery profile may correspond to all communication devices, a class of communication devices, or a single communication device. For instance, database 160 may include user-defined delivery profiles for each subscriber of a data object delivery service, such that a user- or device-specific delivery profiles is readily available for use by data object server 150. As discussed above, the delivery profile, whether generic or device-specific, may specify delivery instructions with respect to one or more content-related attributes, such as file type, file size, and the like. Content attributes specific to the data object retrieved at block 220 are compared to the delivery profile instructions to determine how delivery of the data object should proceed.

For instance, the delivery profile associated with the second communication device may prohibit outright the delivery of certain data objects, such as data objects exceeding a certain size. Thus, as shown at block 240, if delivery of the data object is prohibited by the delivery profile, the process ends. Otherwise, the process continues at block 250.

At block 250, the delivery profile is compared to the content attributes of the data object to determine whether to seek the consent of the user of the target device before delivering the data object. (Those skilled in the art will appreciate that some embodiments of the invention may utilize delivery profile criteria to facilitate the decisions at both blocks 240 and 250, while others implement only one decision or the other.) If the comparison between one or more content attributes associated with the data object and the delivery profile indicates that consent is not required, then the data object is immediately delivered, as shown at block 280. If, on the other hand, the comparison indicates that consent is required, a message requesting consent from the second device is sent to that device, as shown at block 260. The request for consent may be sent by a variety of means; non-limiting examples include a Short Message Service (SMS) message, an instant message, or the like. If the request is rejected, or if no response is received within a pre-determined period, the process ends without delivery of the data object. If the target communication device responds with a message indicating consent, however, then the data object is delivered, as shown at block 280.

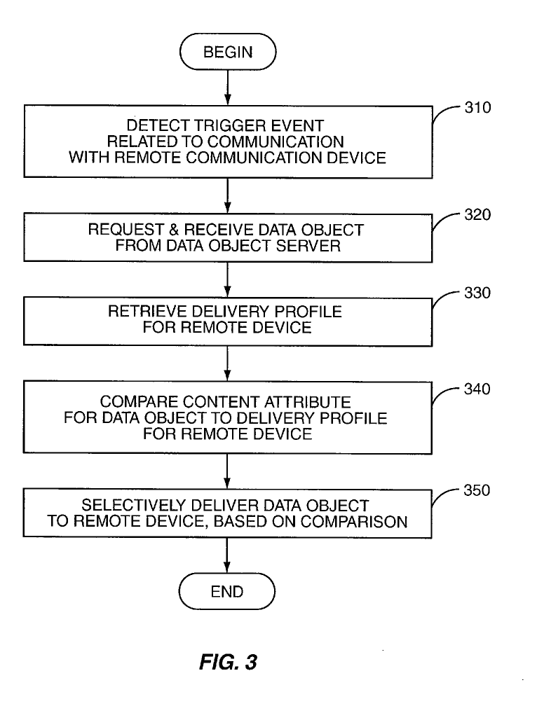

Another embodiment of the present invention is illustrated in the logic flow diagram of FIG. 3. The method of FIG. 3 may be implemented, for example, at mobile terminal 100, while terminal 100 is engaged in a communication session with mobile terminal 125. Again, while the method of FIG. 3 is explained with respect to the components and network configuration of FIG. 1, those skilled in the art will appreciate that the method and its variants may be implemented at various communication nodes in networks of varying configuration.

Assuming for the sake of illustration that the method of FIG. 3 is implemented at mobile terminal 100, the method begins with the detection, at mobile terminal 100, of a trigger event related to communication with a remote communication device, such as mobile terminal 125. This trigger event may be, for example, any of the trigger events discussed above, such as the initiation of communications between mobile terminals 100 and 125, or the transmission of a message from terminal 100 to terminal 125.

At block 320, in response to the trigger event, mobile terminal 100 requests and receives a data object from a data object server, such as data object server 150. As discussed above, this may comprise sending a data object request that includes one or more parameters indicating a trigger event type, an identifier for mobile terminal 100, and/or an identifier for mobile terminal 125.

At block 330, mobile terminal 100 retrieves a delivery profile for the remote device 125. The delivery profile may in some instances be retrieved from local memory at mobile terminal 100, or may be requested and retrieved from a remote data server, such as data object server 150. In some instances, the delivery profile may be requested from the remote device 125 itself.

In any case, as shown at block 340, one or more content attributes for the data object are compared to the delivery profile to determine whether the data object should be delivered to the remote device 125. This comparison may be carried out as discussed above with respect to FIG. 2. Thus, in some cases, delivery is withheld based simply on finding a match between a content attribute of the data object and a delivery restriction criterion in the delivery profile. In other cases, the comparison may determine that consent should be sought from the user of the remote device 125, based on a match between a data object attribute and a delivery profile criterion. Accordingly, based on the comparison, the data object is selectively delivered (or not delivered) to the remote device 125, as shown at block 350.

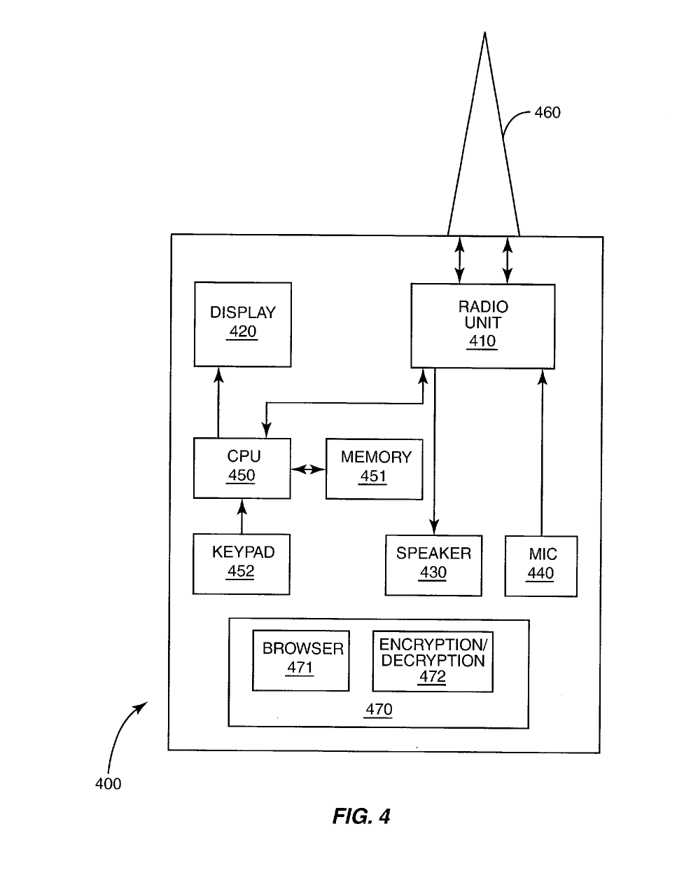

FIG. 4 illustrates an exemplary communication device 400 to be used in one or more embodiments of the present invention. In the pictured embodiment, communication device 400 may comprise a mobile telephone, or a personal digital assistance (PDA) device with mobile telephone capabilities. Communication device 400 includes a central processing unit (CPU) 450, connected to at least one memory unit 451, and at least one display 420. The CPU 450 may also be connected to a keyboard device or area 452 to allow subscribers to enter, for example, digits or alphanumeric characters. The memory unit 451 may include non-volatile memory (e.g., flash, EEPROM or SIM card) in order to retain stored information, should power be temporarily unavailable.

The CPU 450 is further connected to a radio unit 410 configured to convert incoming and outgoing data to and from radio frequency (RF) modulated signals. The radio unit 410 also connects to an antenna 460 for transmission and reception of the RF signals. Radio unit 410 may also directly or indirectly be connected to an earphone 430 and a microphone 440 in order to allow voice communication. Communication device 400 may further comprise a plurality of programs 470, such as a browser 471, that can render at least one type of data object, and an encryption/decryption engine 472, allowing data object requests to be encrypted and data objects to be decrypted. Communication device 400 may optionally be equipped with a cache memory in which it is possible to store and retrieve data objects without occupying transmission resources within the communication network.

In some embodiments of the present invention, CPU 450 and/or other processing logic included in communication device 400 is configured to carry out one or more of the methods described above. In particular, communication device 400 may comprise processing logic configured to detect the occurrence of a trigger event, the trigger event related to communication between device 400 and a second communication device. In response to the trigger event, the processing logic is configured to retrieve a data object; in some embodiments this comprises requesting a data object from a remote data object server and receiving the data object in response. The processing logic may be further configured to compare one or more content attributes for the data object to a pre-determined delivery profile corresponding to the second communication device. Depending on the results of this comparison, the communication device 400 selectively delivers (or does not deliver) the data object to the second communication device, using radio unit 410.

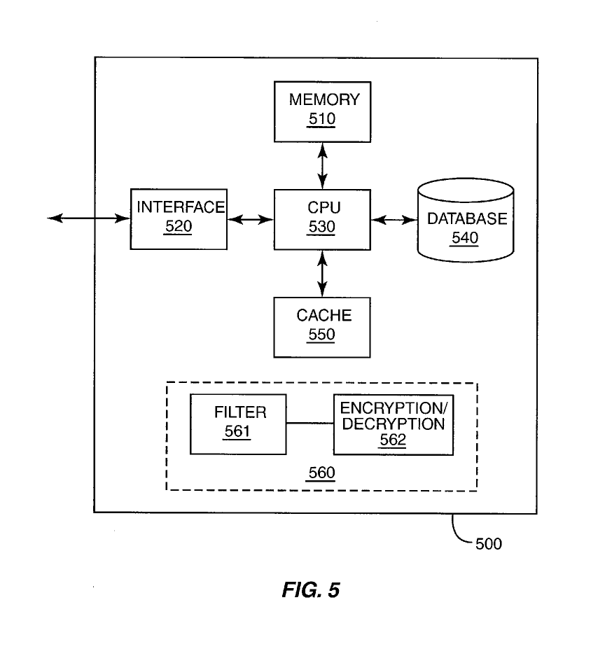

FIG. 5 illustrates a data object server 500, according to one or more embodiments of the present invention. Data object server 500 comprises at least one CPU 530 connected to at least one memory device 510, a cache memory 550, at least one database 540 and at least one network interface 520. Memory devices 510 and databases 540 may include non-volatile memory, such as flash, magnetic, or optical storage devices. Network interface 520 enables the CPU 530 to send and receive data to/from the data network 130. The cache memory 550 allows storage of frequently used data objects so that the CPU 530 may obtain them readily. The database 540 contains the actual data objects that can be requested by a communication device, such as communication device 400, via, for example, the wireless network 120 and Internet 130 pictured in FIG. 1. The data object server may further comprise a number of programs 560 including, but not limited to, a filter 561, allowing the data objects to be optimized according to the rendering capabilities of the communication device 400, and an encryption/decryption engine 562, allowing data object requests to be decrypted and data objects to be encrypted.

In some embodiments of the present invention, the data object server 500 is configured to carry out one or more of the methods described above. In particular, data object server 500 may comprise processing logic (e.g., CPU 530, configured with appropriate software) configured to detect the occurrence of a trigger event associated with communication between a first and second communication device. In some embodiments, the trigger event is detected by the receipt of a data object request from the first communication device. In response to the trigger event/trigger event message, the data object server is configured to retrieve or form a data object. In some embodiments, this comprises retrieving the data object from database 540 or cache 550; in other embodiments or circumstances this may comprise requesting a data object from a remote data object server and receiving the data object in response.

The data object server 500 may be further configured to compare one or more content attributes for the data object to a pre-determined delivery profile for the second communication device; the delivery profile may specify, based on the one or more content attributes whether the data object should be delivered at all, or whether consent from the second communication device should be sought before delivering the data object. Based on the comparison, the data object server 500 selectively delivers (or does not deliver) the data object to the second communication device.

Those skilled in the art will appreciate that the various functions of communication device 400 and data object server 500 may be performed using various combinations of hardware and software. Accordingly, each of the described processing blocks may in some embodiments directly correspond to one or more commercially available or custom microprocessors, microcontrollers, or digital signal processors. In other embodiments, however, two or more of the processing blocks or functional elements of device 400 or data object server 500 may be implemented on a single processor, while functions of other blocks are split between two or more processors. Likewise, memories 451 and 510 are representative of the one or more memory devices containing the software, firmware, and data used to implement base station functionality in accordance with one or more embodiments of the present invention. Thus, these memory devices may include, but are not limited to, the following types of devices: cache, ROM, PROM, EPROM, EEPROM, flash, SRAM, and DRAM.

Those skilled in the art should appreciate that the present invention broadly provides methods and apparatus for selectively transferring data objects to a communication device. The present invention may, of course, be carried out in other specific ways than those herein set forth without departing from the scope and essential characteristics of the invention. Thus, the present invention is not limited to the features and advantages detailed in the foregoing description, nor is it limited by the accompanying drawings. Indeed, the present invention is limited only by the following claims, and their legal equivalents.

What is claimed is:

1. A method for selectively delivering a data object within a communication system, comprising:
detecting the occurrence of a trigger event related to communication between a first communication device and a second communication device;
identifying a data object in response to the detection of the trigger event, based on one or more of the type of trigger event, an identifier for the first communication device, and an identifier for the second communication device;
comparing at least one content attribute for the data object to a pre-determined delivery profile corresponding to the second communication device; and
selectively delivering or not delivering the data object to the second communication device based on said comparing.

2. The method of claim 1, wherein the trigger event comprises one of the initiation of a communication session between the first communication device and the second communication device, the receipt of a message at the first or second communication device, or the sending of a message from the first or second communication device.

3. The method of claim 1, wherein detecting the occurrence of the trigger event comprises receiving a data object request from the first or second communication device, the data object request comprising one or more of a parameter indicating the type of trigger event, the identifier for the first communication device, and the identifier for the second communication device.

4. The method of claim 1, wherein identifying the data object comprises retrieving the data object from a database using at least one of the type of trigger event, the identifier for the first communication device, and the identifier for the second communication device as an index to said database.

5. The method of claim 4, wherein retrieving the data object from a database comprises requesting the data object from a data object server with a data object request including at least one of a parameter indicating the type of trigger event, the identifier for the first communication device, and the identifier for the second communication device as an index to said database

6. The method of claim 1, wherein the pre-determined delivery profile is uniquely associated with the second communication device.

7. The method of claim 1, wherein comparing at least one content attribute for the data object to a pre-determined delivery profile corresponding to the second communication device comprises comparing one or more of a file type, a title, a category, a time, a date, a source, and an author for the data object to the pre-determined delivery profile to determine whether to deliver the data object to the second communication device.

8. A method for selectively delivering a data object within a communication system, comprising:
detecting the occurrence of a trigger event related to communication between a first communication device and a second communication device;
identifying a data object in response to the detection of the trigger event, based on one or more of the type of trigger event, an identifier for the first communication device, and an identifier for the second communication device;
comparing at least one content attribute for the data object to a pre-determined delivery profile corresponding to the second communication device;
selectively requesting consent for delivery of the data object from the second communication device based on said comparing;
delivering the data object to the second communication device if consent is received from the second communication device.

9. The method of claim 8, wherein comparing at least one content attribute for the data object to a pre-determined delivery profile corresponding to the second communication device comprises comparing one or more of a file type, a title, a category, a time, a date, a source, and an author for the data object to the pre-determined delivery profile to determine whether to request consent from a user of the second communication device before delivering the data object.

10. A first communication device configured for communication with a second communication device, wherein the first communication device comprises processing logic configured to:
detect the occurrence of a trigger event related to communication between the first communication device and the second communication device;
identify a data object in response to the detection of the trigger event, based on one or more of the type of trigger event, an identifier for the first communication device, and an identifier for the second communication device;
compare at least one content attribute for the data object to a pre-determined delivery profile corresponding to the second communication device; and
selectively deliver or not deliver the data object to the second communication device based on said comparing.

11. The first communication device of claim 10, wherein the processing logic is configured to identify the data object in response to the detection of the trigger event by retrieving the data object from a database using at least one of a type of trigger event, an identifier for the first communication device, and an identifier for the second communication device as an index to said database.

12. The first communication device of claim 11, wherein the processing logic is configured to retrieve the data object from a database by requesting the data object from a data object server.

13. The first communication device of claim 10, wherein the processing logic is further configured to request the pre-determined delivery profile from one of the second communication device or a data object server.

14. A data object server configured for communication with a first communication device and a second communication device, the data object server comprising processing logic configured to:
detect the occurrence of a trigger event related to communication between the first communication device and the second communication device;
identify a data object in response to the detection of the trigger event, based on one or more of the type of trigger event, an identifier for the first communication device, and an identifier for the second communication device;
compare at least one content attribute for the data object to a pre-determined delivery profile corresponding to the second communication device; and
selectively deliver or not deliver the data object to the second communication device based on said comparing.

15. The data object server of claim 14, wherein the processing logic is configured to detect the occurrence of the trigger event by receiving a data object request from the first or second communication device, the data object request comprising one or more of a parameter indicating the type of trigger event, the identifier for the first communication device, and the identifier for the second communication device.

16. The data object server of claim 14, wherein the processing logic is further configured to request the pre-determined delivery profile from the second communication device.
